(19) United States
(12) Patent Application Publication
(10) Pub. No.: US 2004/0017688 A1
(43) Pub. Date: Jan. 29, 2004

(54) Illumination device for backlighting panels

(75) Inventor: Chung-Shen Liu, Sanchung City (TW)

Correspondence Address: Cooper & Dunham LLP, 1185 Avenue of the Americas, New York, NY, 10036, US

(73) Assignee: Behavior Tech Computer Corporation

(21) Appl. No.: 10/335,744

(22) Filed: Jan. 2, 2003

(30) Foreign Application Priority Data
Jul. 25, 2002 (TW) 091211354

(51) Int. Cl. F21V 8/00

(52) U.S. Cl. 362/555; 362/31; 362/26; 362/30; 362/800

(57) ABSTRACT

An illumination device for backlighting electronic products has a transparent board, two illumination elements and a bracket. The transparent board has a bottom surface and two opposite ends. A recess is defined in each end of the transparent board respectively, and an illumination element is mounted in each recess respectively to produce light that enters the transparent board. Multiple reflecting dots are formed on the bottom surface of the transparent board to reflect the light, and the density of the reflecting dots increases gradually in order. The bracket is attached to the bottom surface of the transparent board and is used to attach the illumination device in electric products. The light is reflected by the reflecting dots and goes out across the transparent board to create a surface-area light source.

### BACKGROUND OF THE INVENTION

1. Field of the Invention

The present invention relates to an illumination device for backlighting panels in, various products, and more particularly to an illumination device that emits light and reflects incident light that is received from a light source.

2. Description of Related Art

Information symbols, icons or letters are used to indicate specific functions in electronic products. A computer keyboard has many letter and punctuation keys, and the keys are used to put data into a computer. In addition to the letter and punctuation keys, the computer keyboard has information symbols, function keys and icons, and each of them represents a specific function. To put data into the computer in a dark environment, an illumination device is mounted under the keys and information symbols to backlight them and make them visible to the operator. The keys and information symbols are made of material that will transmit the light so the operator can easily see the keys on the computer keyboard and put the data into the computer.

Therefor, electroluminescent panels are used as a backlight source. The electroluminescent panels, also known as electroluminescent lamps, are surface-area light sources. Exciting an electroluminescent phosphor in the electroluminescent lamp produces light. Typically, an electric field is applied to excite the electroluminescent phosphor.

Manufacturing the electroluminescent panels is complex and expensive. To keep the price of electronic product down, only high-end products can use electroluminescent panels as a backlight source.

To overcome the shortcomings, the present invention provides an illumination device that has a simple structure to mitigate or obviate the aforementioned problems.

### SUMMARY OF THE INVENTION

An illumination device for backlighting electronic products in accordance with the present invention comprises a transparent board, two illumination elements and a bracket. The transparent board has a bottom surface, a longitudinal center and two opposite ends. A recess is defined in each end of the transparent board, and an illumination element is mounted in each recess.

Multiple reflecting dots are formed on the bottom surface of the transparent board, and the density of the reflecting dots increases gradually as they approach the longitudinal center of the transparent board. The bracket is attached to the bottom surface of the transparent board and is used to mount the transparent board in electronic products. When the illumination elements produce light and the light enters the transparent board, the light will be reflected by the reflecting dots and goes out across the transparent board to create a surface-area light source.

The main objective of the invention is to provide an illumination device for backlighting electronic products, which can be manufactured easily and cheaply.

Other objectives, advantages and novel features of the invention will become more apparent from the following detailed description when taken in conjunction with the accompanying drawings.

### BRIEF DESCRIPTION OF THE DRAWINGS

FIG. 1 is an exploded, perspective view of the illumination device in accordance with the present invention;

FIG. 2 is a bottom plan view of the transparent board of the illumination device in FIG. 1;

FIG. 3 is a front plan view in partial section of the illumination device in FIG. 1;

FIG. 4 is a perspective view of the illumination device in FIG. 1;

FIG. 5 is an operational perspective view of the illumination device in FIG. 1 mounted in a computer keyboard.

FIG. 6 is another operational perspective view of the illumination device in FIG. 1 mounted in the computer keyboard in FIG. 6; and

FIG. 7 is a bottom plan view of another embodiment of the transparent board of the illumination device in FIG. 1.

### DETAILED DESCRIPTION OF PREFERRED EMBODIMENT

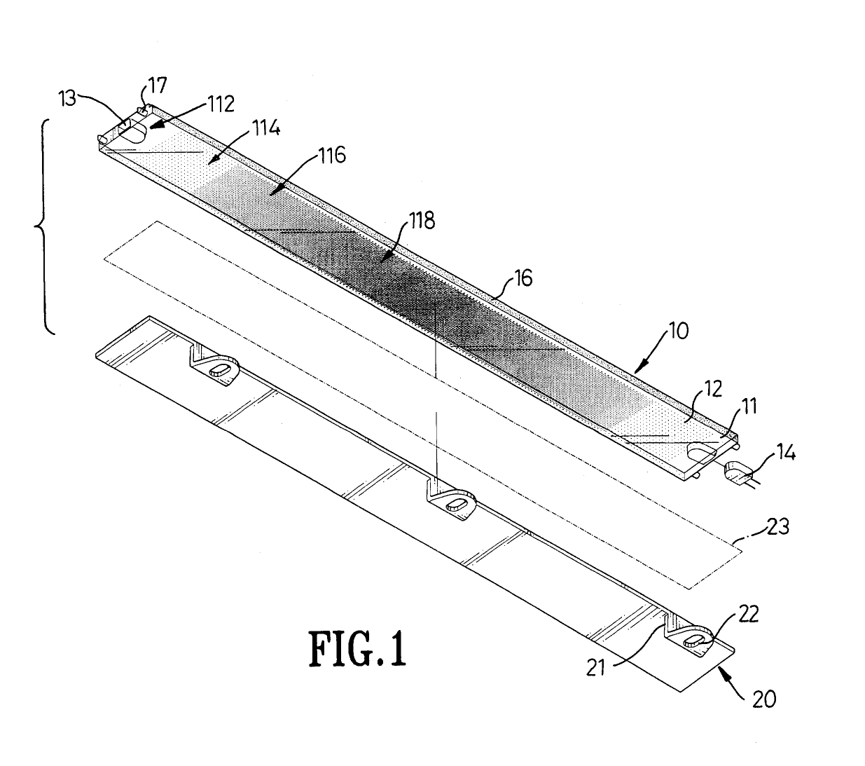

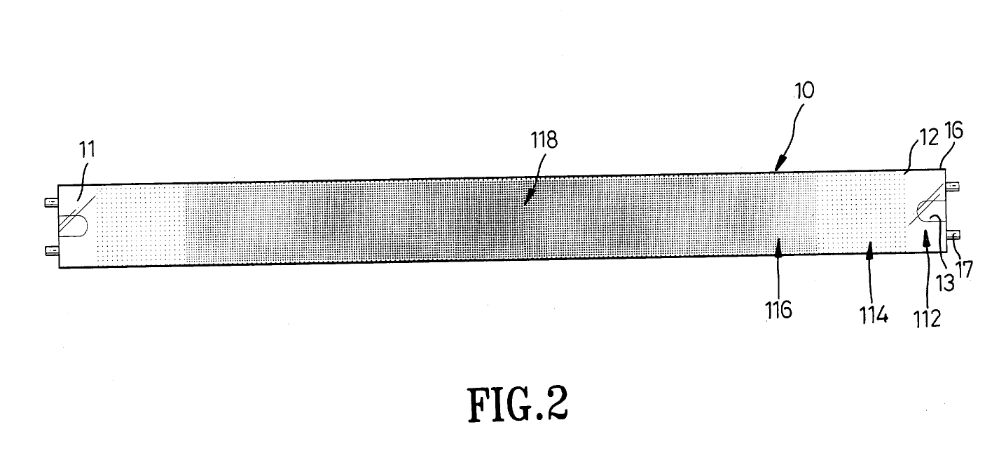

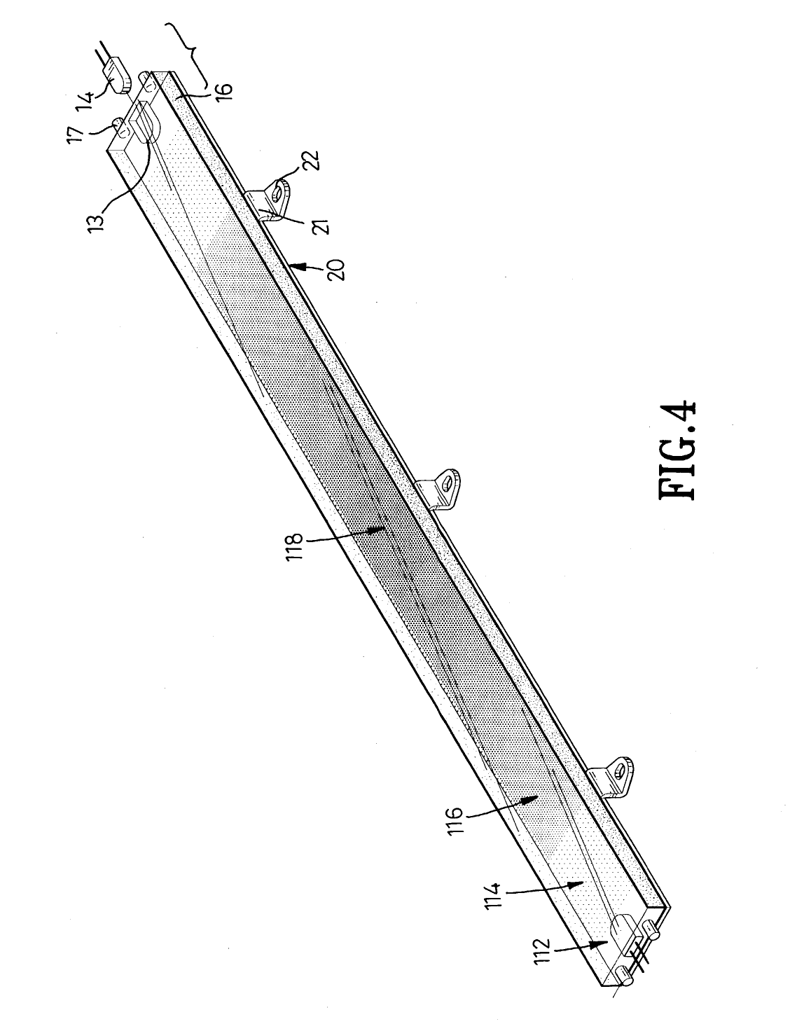

With reference to FIGS. 1 to 4, an illumination device in accordance with the present invention includes a transparent board (10), a bracket (20), two illumination elements (14) and a light reflecting layer (23).

The transparent board (10) is made of any transparent solid material. In this embodiment, the transparent board (10) is made of transparent acrylic. The transparent board (10) has a bottom surface (11), two side surfaces (not numbered), a longitudinal center (not numbered) and two opposite ends (not numbered). Multiple reflecting dots (12) in different densities are printed, etched or molded on the bottom surface (11) of the transparent board (10). The density of the reflecting dots (12) on the bottom surface (11) symmetrically defines a transparent area (112), a low density area (114), a medium density area (116) and a high density area (118) sequentially from each opposite end toward the longitudinal center of the transparent board (10).

There are no any reflecting dots (12) on the transparent area (112). The density of the reflecting dots (12) is lowest in the low density area (114). The density of the reflecting dots (12) in the middle density area (116) is higher than in the low density area (114). The density of the reflecting dots (12) in the high density area (118) is highest.

The reflecting dots (12) are used to reflect light, and each reflecting dot (12) has a diameter. An interval is formed between adjacent reflecting dots (12). The diameter of and the interval between reflecting dots (12) are the same in a given area. The diameter of the reflecting dots (12) is proportional to the density of the reflecting dots (12), and the interval between the reflecting dots (12) is inversely proportional to the density of the reflecting dots (12). Low density of the reflecting dots (12) means the reflecting dots (12) have a small diameter and a large interval between adjacent reflecting dots (12) in the low density area (114). A higher density of the reflecting dots (12) means the reflecting dots (12) have a larger diameter and a smaller interval between adjacent reflecting dots (12) in the specific area.

Recesses (13) are defined respectively in opposite ends of the transparent board (10), and an illumination element (14) is mounted in each recess (13). The illumination element (14) can be a light emitting diode (LED) that produces light. The light enters the transparent board (10) and is reflected by the reflecting dots (12).

The bracket (20) has a top surface (not numbered), a bottom surface (not numbered) and a side (not numbered). The bracket (20) is made of metal and electroplated with chromium to form a mirror on the top surface of the bracket (20). Three attachments (21) are formed separately on the bottom surface at the side of the bracket (20). An attachment hole (22) is defined in each attachment (21) respectively, and a screw passes through each attachment hole (22) to attach the bracket (20) to an object.

The bottom surface (11) of the transparent board (10) is attached to the top surface of the bracket (20). The light reflecting layer (23) is attached between the top surface of the bracket (20) and the bottom surface (11) of the transparent board (10). The light reflecting layer (23) can be an opaque polyester film such as “mylar” or a piece of reflecting paper.

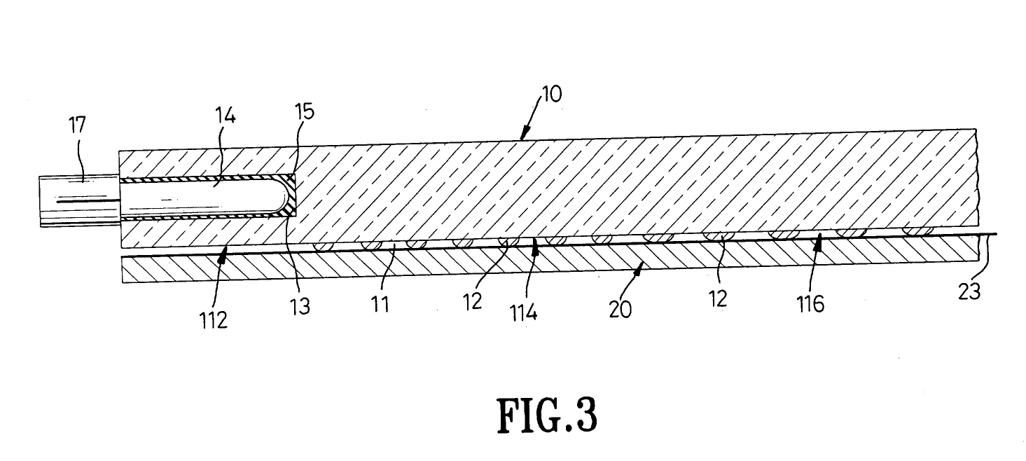

With reference to FIGS. 1 and 3, a shading layer (16) is formed on the side surface of the transparent board (10) respectively by rubbing ink on the side surface of the transparent board (12). A high-transmittance filler (15) is caulked between the illumination element (14) and the recess (13). The high-transmittance filler (15) raises the transmission efficiency to transmit the light produced by the illumination element (14). Positioning pins (17) are formed at each end of the transparent board (10) to hold the transparent board (10) in position.

The lights produced by the illumination elements (14) enter the transparent board (10) from the ends, and the shading layer (16) and the light reflecting layer (23) reflect a part of the light. The reflecting dots (12) will also reflect the light, and a higher density of reflecting dots (12) reflects more light. Because the reflecting dots (12) are formed gradually on the bottom surface (11) of the transparent board (10), the light entering the transparent board (10) is reflected to create uniform light across the top surface of the transparent board (10) as a surface-area light source. Therefor, the illumination device is provided to backlight the keys or information symbols of the electric products.

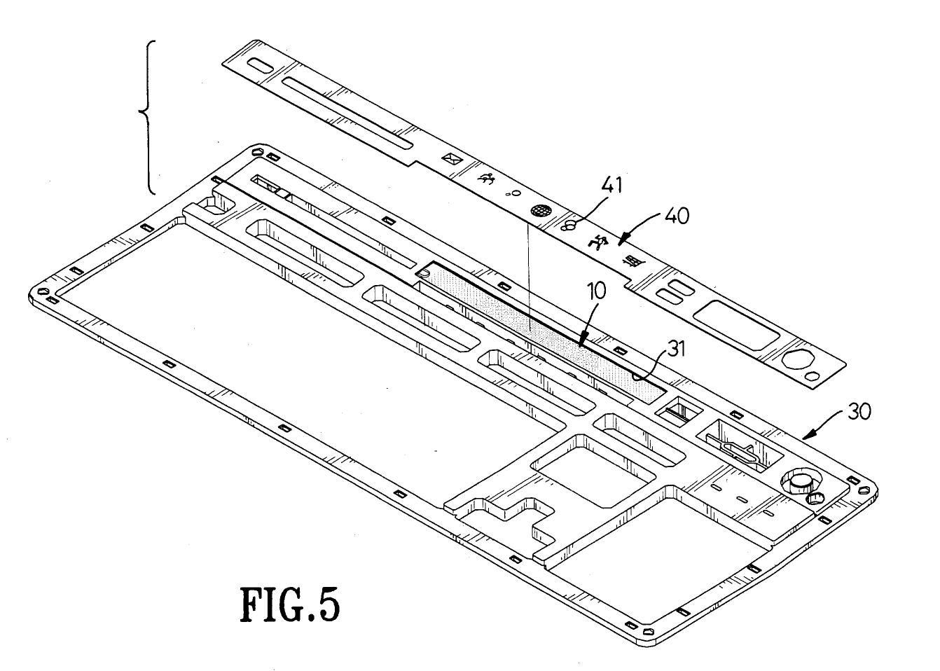

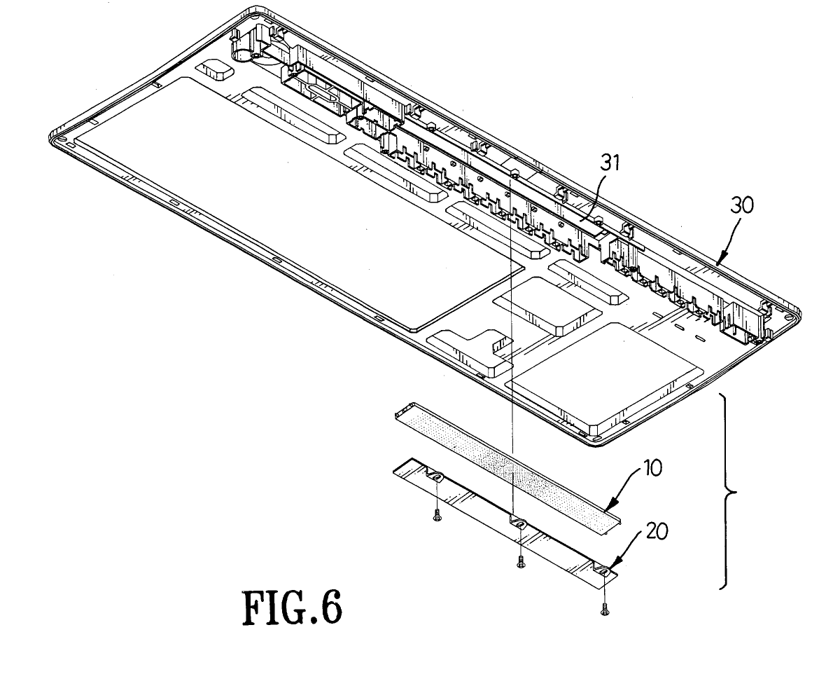

With reference to FIGS. 5 and 6, the illumination device is attached to a computer keyboard (30). The keyboard (30) has a top surface (not numbered), and a mounting hole (31) is defined through the top surface of the keyboard (30). The mounting hole (31) has two ends corresponding to the opposite ends of the transparent board (10). Two positioning holes (not shown) corresponding to the positioning pins (17) are defined in each end of the mounting hole (31) respectively. The illumination device is mounted in the mounting hole (31) and the positioning pins (17) are mounted in the positioning holes respectively to attach the transparent board (10) to the keyboard (30).

A panel (40) is attached to the top surface of the keyboard (30) to cover the illumination device. The panel (40) has several function keys (41) that are located corresponding to the illumination device. A screw (not numbered) passes through the attachment hole (22) in the attachment (20) and screws into the keyboard (30) to fasten the illumination device to the keyboard (30). Thus, a user can see and use the function keys (41) in the dark.

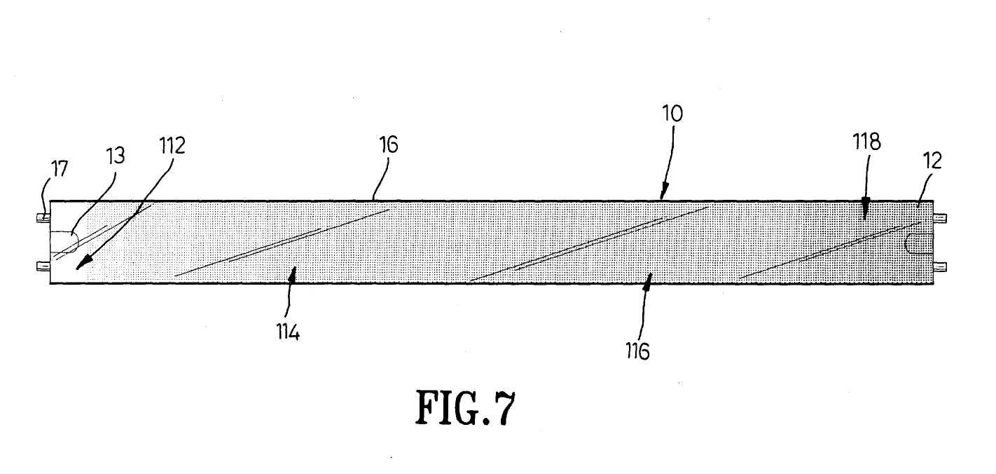

With reference to FIG. 7, the density of the reflecting dots (12) increases gradually from one end to the other end in another embodiment of the transparent board (10). Consequently, the bottom surface (11) of the transparent board (10) is divided progressively to a transparent area (112) at one end, a low density area (114), a medium density area (116) and a high density area (118) at the opposite end of the transparent board (10). A recess (13) is defined in one end away from the high density area (118) of the transparent board (10). An illumination element is mounted in the recess (13) to produce the light.

The illumination device in accordance with the present invention has a simple structure and is cheap to manufacture. Every part of the illumination device is easy to make and is cheap. The illumination device can be widely used in panels in many applications.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illumination device comprising:
a transparent board having a bottom surface, two side surfaces, a longitudinal center, two opposite ends and multiple reflecting dots formed on the bottom surface of the transparent board with a density increasing gradually and symmetrically from each opposite end toward the longitudinal center of the transparent board, each reflecting dot having a diameter and an interval formed between adjacent reflecting dots;
at least one illumination element mounted in each respective one of the opposite ends of the transparent board; and
a bracket used for supporting the transparent board having a top surface, and the top surface of the bracket attached to the bottom surface of the transparent board.

2. The illumination device as claimed in claim 1, wherein at least one recess is defined in each of the opposite ends of the transparent board, and each at least one illumination element is mounted in a respective one of the at least one recess.

3. The illumination device as claimed in claim 2, wherein a transparent area, a low density area, a medium density area and a high density area are formed in order on the bottom surface of the transparent board from each end toward the longitudinal center of the transparent board by means of selectively changing at least one of the densities, the diameters and the intervals of the reflecting dots.

4. The illumination device as claimed in claim 3, wherein a shading layer is formed on each of the side surfaces of the transparent board by rubbing ink onto the side surfaces, and a mirror is electroplated on the top surface of the bracket.

5. The illumination device as claimed in claim 4, wherein a light reflecting layer is attached between the bottom surface of the transparent board and the top surface of the bracket.

6. The illumination device as claimed in claim 5, wherein the light reflecting layer is a polyester film.

7. The illumination device as claimed in claim 5, wherein the light reflecting layer is a piece of reflecting paper.

8. The illumination device as claimed in claim 6, wherein the illumination elements are LEDs.

9. The illumination device as claimed in claim 7, wherein the illumination elements are LEDs.

10. The illumination device as claimed in claim 5, wherein multiple attachments are separately attached on the bottom surface of the bracket and are adapted to attach the bracket to an object.

11. An illumination device comprising:
a transparent board having a bottom surface, two side surfaces, a first end, a second end and multiple reflecting dots formed on the bottom surface of the transparent board with a density increasing gradually from the first end to the second end of the transparent board, each reflecting dot having a diameter and an interval formed between adjacent reflecting dots;
at least one illumination element mounted in the first end of the transparent board; and
a bracket used for supporting the transparent board having a top surface, and the top surface of the bracket attached to the bottom surface of the transparent board.

12. The illumination device as claimed in claim 11, wherein at least one recess is defined in first end of the transparent board, and each at least one illumination element is mounted in a respective one of the at lease one recess.

13. The illumination device as claimed in claim 12, wherein a transparent area, a low density area, a medium density area and a high density area are formed sequentially on the bottom surface of the transparent board from the first end to the second end of the transparent board by means of selectively changing one of the densities, the diameters and the intervals of the reflecting dots.

14. The illumination device as claimed in claim 13, wherein a shading layer is formed on each of the side surfaces of the transparent board by rubbing ink onto the side surfaces, and a mirror is electroplated on the top surface of the bracket.

15. The illumination device as claimed in claim 14, wherein a light reflecting layer is attached between the bottom surface of the transparent board and the top surface of the bracket.

16. The illumination device as claimed in claim 15, wherein the light reflecting layer is a polyester film.

17. The illumination device as claimed in claim 15, wherein the light reflecting layer is a piece of reflecting paper.

18. The illumination device as claimed in claim 16, wherein the illumination element is LED.

19. The illumination device as claimed in claim 17, wherein the illumination element is LED.

20. The illumination device as claimed in claim 15, wherein multiple attachments are separately attached on the bottom surface of the bracket and are adapted to attach the bracket to an object.
